(19) United States
(12) Patent Application Publication
(10) Pub. No.: US 2025/0055075 A1
(43) Pub. Date: Feb. 13, 2025

(54) THERMAL BARRIER ASSEMBLY FOR TRACTION BATTERY PACK

(71) Applicant: Ford Global Technologies, LLC, Dearborn, MI (US)

(72) Inventors: Wen Dai, Northville, MI (US); Jianwen Yi, West Bloomfield, MI (US)

(21) Appl. No.: 18/447,639

(22) Filed: Aug. 10, 2023

(51) Int. Cl. H01M 10/658; H01M 10/625; H01M 50/211; H01M 50/271

(52) U.S. Cl. CPC H01M 10/658; H01M 10/625; H01M 50/211; H01M 50/271; H01M 2220/20

(57) ABSTRACT

A traction battery pack assembly includes an enclosure assembly that provides an interior area, and a cell stack within the interior area. The cell stack has a plurality of battery cells disposed along a cell stack axis. Each battery cell includes at least one terminal tab that projects outward from the cell stack axis. A plurality of insulative pieces are bound together to provide a thermal barrier within the interior area.

### TECHNICAL FIELD

This disclosure relates generally to a thermal barrier for a traction battery pack and, more particularly, to a thermal barrier that provides passages for vent byproducts.

### BACKGROUND

A traction battery pack of an electrified vehicle can include an enclosure assembly that holds groups of battery cells arranged in one or more cell stacks. Open areas within the enclosure can be filled with various types of thermal barriers to help control thermal propagation.

### SUMMARY

In some aspects, the techniques described herein relate to a traction battery pack assembly, including: an enclosure assembly that provides an interior area; a cell stack within the interior area, the cell stack having a plurality of battery cells disposed along a cell stack axis, each battery cell within the plurality of battery cells includes at least one terminal tab that project outward from the cell stack axis; and a plurality of insulative pieces that are bound together to provide a thermal barrier within the interior area.

In some aspects, the techniques described herein relate to a traction battery pack assembly, wherein the plurality of insulative pieces are separate and distinct from one other.

In some aspects, the techniques described herein relate to a traction battery pack assembly, wherein the plurality of insulative pieces are not directly attached to each other.

In some aspects, the techniques described herein relate to a traction battery pack assembly, wherein the plurality of insulative pieces are foam.

In some aspects, the techniques described herein relate to a traction battery pack assembly, wherein the foam is a closed-cell foam.

In some aspects, the techniques described herein relate to a traction battery pack assembly, wherein the plurality of insulative pieces are detached from each other and are each attached to a joining member that binds together the plurality of insulative pieces.

In some aspects, the techniques described herein relate to a traction battery pack assembly, further including an adhesive tape that binds together the plurality of insulative pieces.

In some aspects, the techniques described herein relate to a traction battery pack assembly, further including membrane sheet that binds together the plurality of insulative pieces.

In some aspects, the techniques described herein relate to a traction battery pack assembly, further including a mesh sheet that binds together the plurality of insulative pieces.

In some aspects, the techniques described herein relate to a traction battery pack assembly, wherein the thermal barrier is disposed along a vertical top of the cell stack.

In some aspects, the techniques described herein relate to a traction battery pack assembly, wherein the enclosure assembly includes a plurality of enclosure vents, the thermal barrier disposed between the cell stack and at least one enclosure vent within the plurality of enclosure vents.

In some aspects, the techniques described herein relate to a traction battery pack assembly, wherein the enclosure assembly includes an enclosure cover, the thermal barrier disposed between the enclosure cover and the cell stack.

In some aspects, the techniques described herein relate to a traction battery pack assembly, wherein the thermal barrier is compressed between the enclosure cover and the cell stack.

In some aspects, the techniques described herein relate to a traction battery pack assembly, wherein the plurality of battery cells are a plurality of pouch battery cells.

In some aspects, the techniques described herein relate to a traction battery pack assembly, wherein each insulative piece within the plurality of insulative pieces has a rectangular axial cross-section.

In some aspects, the techniques described herein relate to a traction battery pack thermal barrier providing method, including: forming a plurality of insulative pieces; binding the plurality of insulative pieces together to provide a thermal barrier; and positioning the thermal barrier within an enclosure of a traction battery pack.

In some aspects, the techniques described herein relate to a method, further including, within the traction battery pack providing at least one vent path between the plurality of insulative pieces.

In some aspects, the techniques described herein relate to a method, wherein the plurality of insulative pieces are pieces of closed-cell foam.

In some aspects, the techniques described herein relate to a method, wherein the binding includes adhesively binding.

In some aspects, the techniques described herein relate to a method, wherein the binding includes binding using a mesh sheet.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1 according to an exemplary aspect of the present disclosure.

FIG. 3 illustrates a battery cell from the battery pack of FIG. 2.

FIG. 4 illustrates a perspective view of the battery pack of FIG. 2.

FIG. 5 illustrates a section view taken at line 5-5 in FIG. 4.

FIG. 6 illustrates a perspective view of a thermal barrier from the battery pack of FIG. 2.

FIG. 7 illustrates a top view of the thermal barrier of FIG. 6.

FIG. 8 illustrates a thermal barrier for use in the battery pack of FIG. 2 according to another exemplary embodiment.

FIG. 9 illustrates a thermal barrier for use in the battery pack of FIG. 2 according to yet another exemplary embodiment.

FIG. 10 illustrates a thermal barrier for use in the battery pack of FIG. 2 according to yet another exemplary embodiment.

### DETAILED DESCRIPTION

This disclosure details exemplary thermal barriers used in a traction battery pack. The thermal barriers can, among other things, help to shield battery cells that are not venting from thermal energy associated with a battery cell that is venting. Shielding the battery cells that are not venting from thermal energy can help to prevent thermal energy levels in these battery cells from increasing and causing these battery cells to vent.

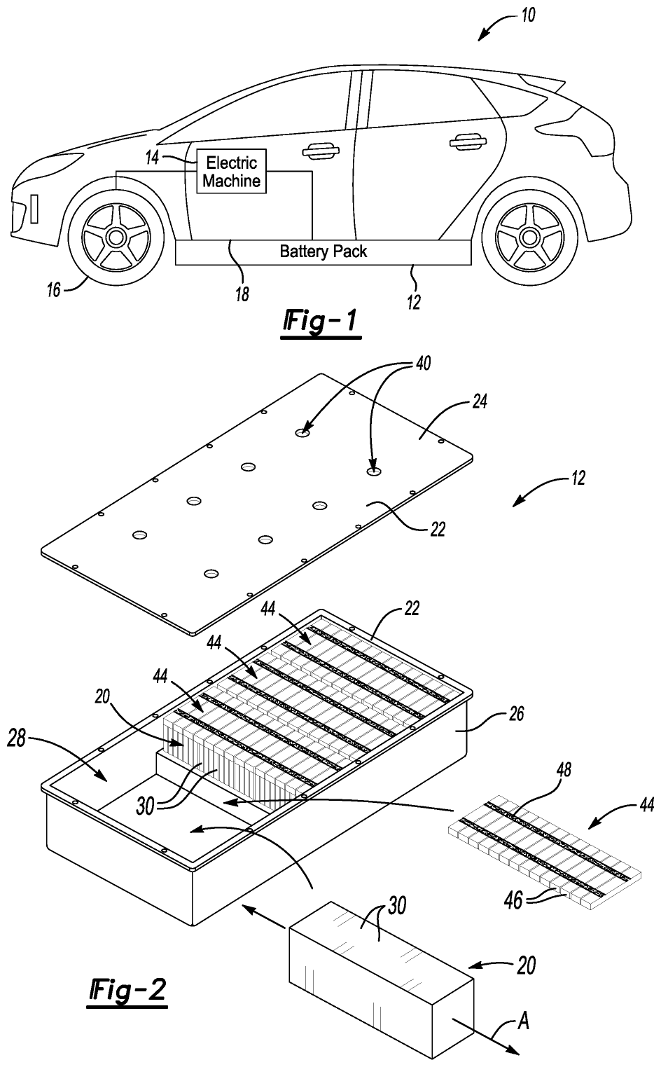

With reference to FIG. 1, an electrified vehicle 10 includes a battery pack 12, an electric machine 14, and wheels 16. The battery pack 12 powers the electric machine 14, which can convert electrical power to mechanical power to drive the wheels 16.

The battery pack 12 is, in the exemplary embodiment, secured to an underbody 18 of the electrified vehicle 10. The battery pack 12 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

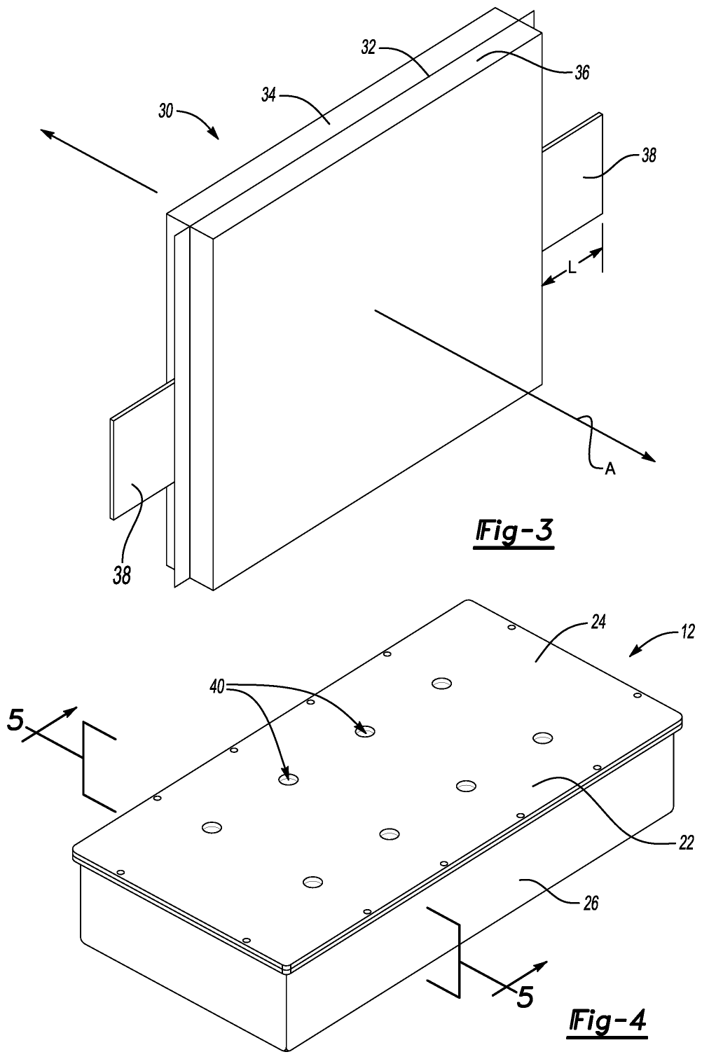

With reference now to FIGS. 2 to 4, the battery pack 12 includes a plurality of cell stacks 20 held within an enclosure assembly 22. In the exemplary embodiment, the enclosure assembly 22 includes an enclosure cover 24 and an enclosure tray 26. The enclosure cover 24 is secured to the enclosure tray 26 to provide an interior area 28 that houses the cell stacks 20. The enclosure cover 24 can be secured to the enclosure tray 26 using mechanical fasteners (not shown), for example.

Each of the cell stacks 20 includes a plurality of battery cells 30 (or simply, “cells”) disposed along a respective cell stack axis A. Within each cell stack 20, the battery cells 30 are stacked side-by-side relative to each other along the cell stack axis A. The cells 30 are shown in highly schematic form in FIG. 2.

The cells 30 can store and supply electrical power. Although specific numbers of the cell stacks 20 and cells 30 are illustrated in the various figures of this disclosure, the battery pack 12 could include any number of the cell stacks 20 having any number of individual battery cells 30.

In this exemplary embodiment, the battery cells 30 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

The example battery cells 30 include a crimped edge 32 where a first case 34 of the battery cell 30 is joined to a second case 36 of the battery cell 30. The crimped edge 32 can extend partially or completely about a circumferential perimeter of the associated battery cell 30. Terminal tabs 38 of the battery cells 30 project outward away from the cell stack axis A through the crimped edge 32. When the battery cell 30 is within the cell stack 20, the terminal tabs 38 extend outward from the cell stack axis A and can connect to a busbar, for example.

From time to time, pressure and thermal energy within one or more of the battery cells 30 can increase. The pressure and thermal energy increase can be due to an overcharge condition, for example. The pressure and thermal energy increase can cause the associated battery cell 30 to rupture and expel vent byproducts, such as gas and debris, from within the battery cell 30.

The vent byproducts can be released from the associated battery cell 30 through a ruptured area of the associated battery cell 30, such as a ruptured area of the crimped edge 32. The vent byproducts could also be released through a designated vent within the one or both of the first case 34 and the second case 36. The designated vent could be a membrane that yields in response to increased pressure.

The enclosure cover 24, in this example, includes a plurality of enclosure vents 40. The enclosure vents 40 can release vent byproducts from within the battery pack 12. As can be appreciated, when one of the battery cells 30 is venting, it can be desirable for vent byproducts to move through one of the enclosure vents 40 rather than swirling and moving around within the interior area 28. Thermal energy from the vent byproducts can cause the venting event to cascade to other battery cells 30 that are not venting.

To facilitate flow of vent byproducts toward the enclosure vents 40 and to shield battery cells 30 that are not venting from the vent byproducts, the battery pack 12 includes a plurality of thermal barriers 44 within the interior area 28. The thermal barriers 44 are placed, in this example, along a vertical top of the cell stacks 20. In other examples, the thermal barriers 44 could be placed in other areas of the interior area 28. The thermal barriers 44 could be used with other insulative materials, such as foam fingers placed along the outer horizontal sides of the cell stacks 20. Vertical and horizontal, for purposed of this disclosure, are with reference to ground and a general orientation of the battery pack 12 when installed within the electrified vehicle 10.

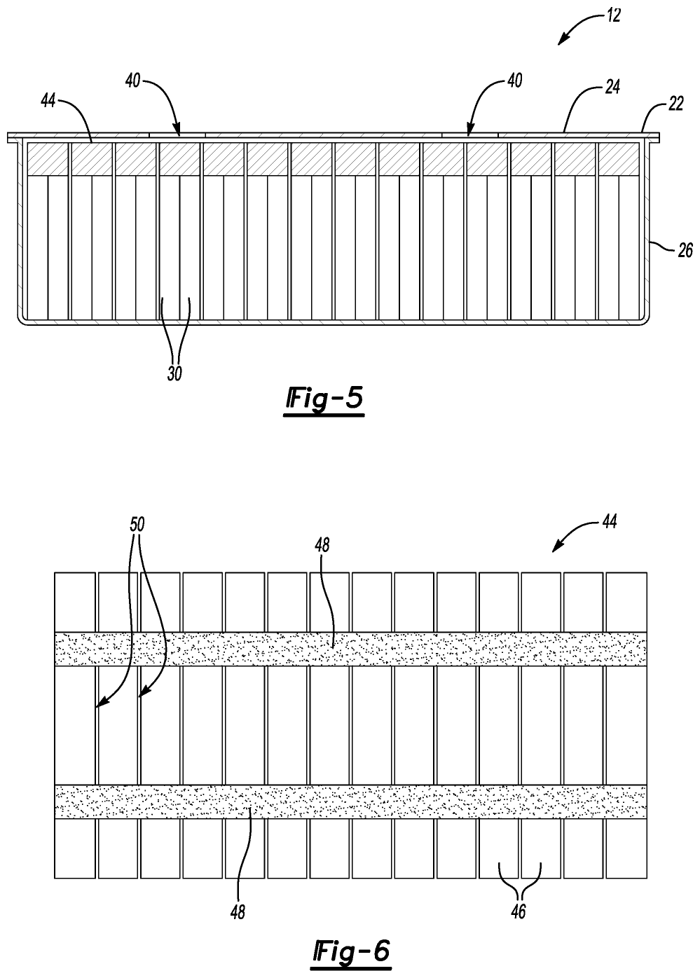

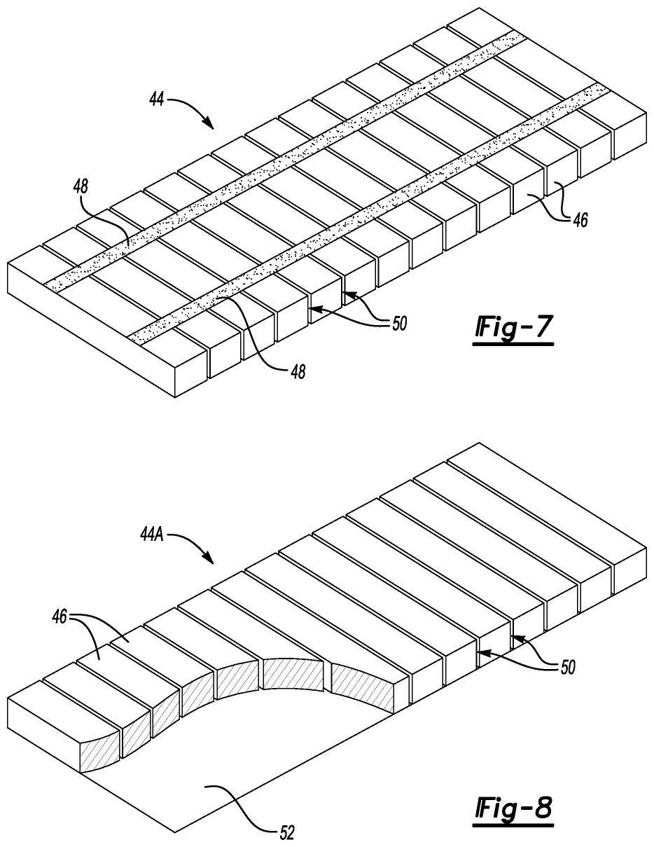

With reference now to FIGS. 6 and 7 and continuing reference to FIGS. 2-5, the example thermal barriers 44 includes a plurality of insulative pieces 46 that are bound together. The plurality of insulative pieces 46 are separate and distinct from one another. The plurality of insulative pieces 46 can be foam and, more particularly, a closed-cell foam. The plurality of insulative pieces 46 have a rectangular axial cross-section.

The insulative pieces 46 are not directly attached to each other. To join the insulative pieces 46, the thermal barrier 44 includes at least one joining member that binds together the insulative pieces 46. The joining member is an adhesive tape 48 in this example. The joining member is shown on an upwardly facing side of the thermal barrier 44 but could instead, or additionally, be on the downwardly facing side of the thermal barrier 44. The insulative pieces 46 are each in individually attached to the joining member and detached from each other.

As the insulative pieces 46 are detached from each other, the thermal barriers 44 include gaps 50 between adjacent insulative pieces 46. When one of the cells 30 beneath the thermal barrier 44 vents, the vent byproducts can move upward though the gaps 50 and then through the enclosure vents 40. The thermal barrier 44 with the gaps 50 provides a flow passage for the vent byproducts to move toward the enclosure cover 24 rather than flowing axially along the cell stack 20 and potentially leading to a cascading thermal event.

The thermal barrier 44 are disposed between the enclosure vents 40 and the cell stack 20 in this example. In some examples, the thermal barrier 44 is compressed between the enclosure cover 24 and the cell stacks 20. The thermal barrier 44 could be disposed in other areas of the battery pack 12 in other examples, such as alongside the cell stacks 20.

An exemplary method of providing a thermal barrier for the battery pack 12 can include forming the plurality of insulative pieces 46 and then binding together the plurality of insulative pieces 46 to provide the thermal barrier 44. The thermal barrier 44 is then positioned atop one of the cell stacks 20 within the enclosure assembly 22.

With reference to FIG. 8, another example thermal barrier 44A includes the insulative pieces 46 bound together with membrane sheet 52. During a venting event, the thermal energy from the vent byproducts can melt portions of the membrane sheet 52 to create an opening for the vent byproducts to pass through the gaps 50 to the enclosure vents 40. Temperature of the vent byproducts decreases as the vent byproducts move away from the battery cells 30 that are venting. After passing through one or more gaps 50 in the thermal barrier 44A, the temperature of the vent byproducts may no longer be high enough to melt the membrane sheet 52. In such examples, the membrane sheet 52 can help to block vent products that have passed through one or more gaps 50 in the thermal barrier 44A from passing back through other gaps 50 in the membrane sheet 52 and moving adjacent to other battery cells 30 that are not venting.

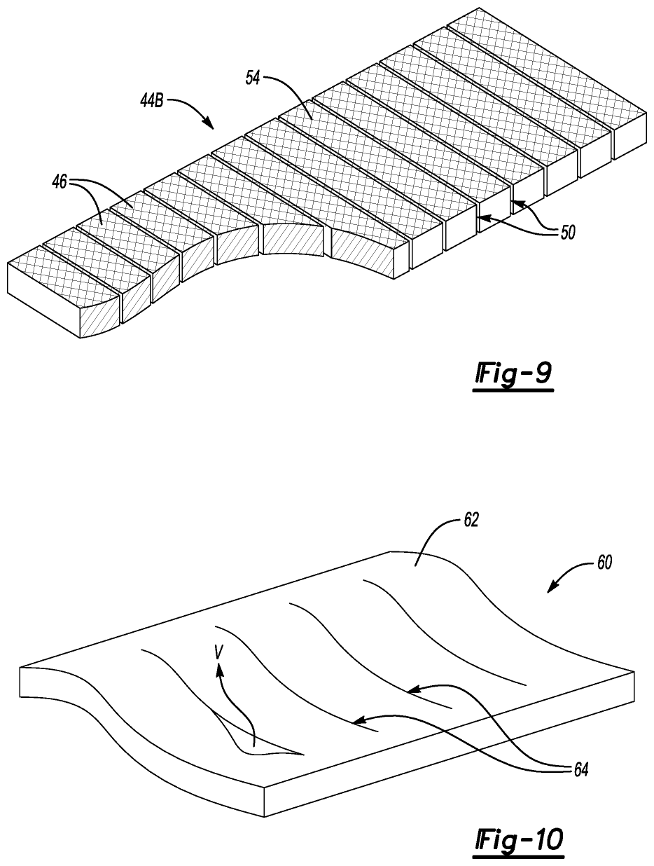

With reference to FIG. 9, yet another example thermal barrier 44B includes the insulative pieces 46 bound together with a mesh sheet 54. During a venting event, the vent byproducts can pass through openings in the mesh sheet 54 and then pass through the gaps 50 to the enclosure vents 40. In this example, the mesh sheet 54 is on the top of the insulative pieces 46. In another example, the mesh sheet 54 could be on the bottom of the insulative pieces 46.

With reference to FIG. 10, yet another thermal barrier 60 is a provided by a foam blanket 62 or foam pad. The foam blanket 62 is includes a plurality of cuts 64. During a venting event, the vent byproducts can force open the cuts 64 which allows the vent byproducts V to pass through the foam blanket 62 to the enclosure vents 40.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly that provides an interior area;
a cell stack within the interior area, the cell stack having a plurality of battery cells disposed along a cell stack axis, each battery cell within the plurality of battery cells includes at least one terminal tab that project outward from the cell stack axis; and
a plurality of insulative pieces that are bound together to provide a thermal barrier within the interior area.

2. The traction battery pack assembly of claim 1, wherein the plurality of insulative pieces are separate and distinct from one other.

3. The traction battery pack assembly of claim 1, wherein the plurality of insulative pieces are not directly attached to each other.

4. The traction battery pack assembly of claim 1, wherein the plurality of insulative pieces are foam.

5. The traction battery pack assembly of claim 4, wherein the foam is a closed-cell foam.

6. The traction battery pack assembly of claim 1, wherein the plurality of insulative pieces are detached from each other and are each attached to a joining member that binds together the plurality of insulative pieces.

7. The traction battery pack assembly of claim 1, further comprising an adhesive tape that binds together the plurality of insulative pieces.

8. The traction battery pack assembly of claim 1, further comprising membrane sheet that binds together the plurality of insulative pieces.

9. The traction battery pack assembly of claim 1, further comprising a mesh sheet that binds together the plurality of insulative pieces.

10. The traction battery pack assembly of claim 1, wherein the thermal barrier is disposed along a vertical top of the cell stack.

11. The traction battery pack assembly of claim 1, wherein the enclosure assembly includes a plurality of enclosure vents, the thermal barrier disposed between the cell stack and at least one enclosure vent within the plurality of enclosure vents.

12. The traction battery pack assembly of claim 1, wherein the enclosure assembly includes an enclosure cover, the thermal barrier disposed between the enclosure cover and the cell stack.

13. The traction battery pack assembly of claim 12, wherein the thermal barrier is compressed between the enclosure cover and the cell stack.

14. The traction battery pack assembly of claim 1, wherein the plurality of battery cells are a plurality of pouch battery cells.

15. The traction battery pack assembly of claim 1, wherein each insulative piece within the plurality of insulative pieces has a rectangular axial cross-section.

16. A traction battery pack thermal barrier providing method, comprising:
forming a plurality of insulative pieces;
binding the plurality of insulative pieces together to provide a thermal barrier; and
positioning the thermal barrier within an enclosure of a traction battery pack.

17. The method of claim 16, further comprising, within the traction battery pack providing at least one vent path between the plurality of insulative pieces.

18. The method of claim 16, wherein the plurality of insulative pieces are pieces of closed-cell foam.

19. The method of claim 16, wherein the binding comprises adhesively binding.

20. The method of claim 16, wherein the binding includes binding using a mesh sheet.
